(19) United States
(12) Patent Application Publication
(10) Pub. No.: US 2026/0257245 A1
(43) Pub. Date: Sep. 3, 2026

(54) SYSTEMS AND METHODS FOR SORTING OBJECTS

(71) Applicant: COGNEX CORPORATION, Natick, MA (US)

(72) Inventors: Nickolas J. MULLAN, Ambler, PA (US); Ben R. CAREY, Cambridge, MA (US); Shane M. LACHAPPELLE, South Lyon, MI (US)

(21) Appl. No.: 18/869,523

(22) PCT Filed: May 22, 2024
(86) PCT No.: PCT/US2024/030609

§ 371 Date: Nov. 26, 2024

Related U.S. Application Data
(60) Provisional application No. 63/503,590, filed on May 22, 2023.

(51) Int. Cl. B07C 5/34; B07C 5/10; B07C 5/16

(52) U.S. Cl. CPC B07C 5/3412; B07C 5/10; B07C 5/16

(57) ABSTRACT

To sort objects, runtime information can be received for one or more previous objects (224, 226, 228) processed by a system, including at least one object (224) with first symbol information that can indicate a first type of object. Symbol information of a first object (222) can be attempted to be obtained. In response to failing to obtain the symbol information, the first object (222) can be determined to be the first type of object, based on the runtime information. Routing of the first object (222) can be controlled within a transport system (202) based on determining that the first object is the first type of object.

### CROSS-REFERENCE TO RELATED APPLICATIONS

This application claims priority to and incorporated by reference U.S. Provisional Patent Application No. 63/503,590, filed May 22, 2023.

### STATEMENT REGARDING FEDERALLY SPONSORED RESEARCH

Not applicable.

### BACKGROUND

Sorting systems generally facilitate the movement of objects though transport systems (e.g., in a logistical object distribution system). As objects move through transport systems, issues can arise that may affect the efficiency and accuracy of routing for the objects. For example, some scans may result in no-read issue classifications, in which symbol information (e.g., a barcode string) is unable to be obtained for a given object (e.g., due to a symbol not being present on the object, the symbol not being of a sufficient quality, etc.). When a no-read issue classification occurs for an object, the object is typically required to be rerouted in some manner, including, for example, recirculating the object for a subsequent rescanning of the object, manual intervention for the object, etc.

### SUMMARY OF THE DISCLOSURE

Some examples of the disclosure provide a sorting for use to control routing of objects within a transport system (e.g., including a conveyor) that supports and moves one or more objects for routing operations. The sorting can include a symbol scanner that can be configured to scan one or more symbols of each of the one or more objects to obtain corresponding symbol information as the one or more objects move within the transport system. The sorting can include one or more computing devices in communication with the symbol scanner. The one or more computing devices can be configured to obtain runtime data for one or more previous objects that were processed by the sorting before a first object, and attempt to obtain, using the symbol scanner, symbol information on the first object as the first object moves within the transport system. The symbol information can indicate an object type of the first object. The one or more computing devices can be configured to in response to failing to obtain the symbol information, determine, based on the runtime data, that the first object is a first type of object associated with first symbol information, and control routing of the first object within the transport system based on determining that the first object is the first type of object.

In some examples, the runtime data can indicate, for one or more of a predetermined period of time or a processing by the transport system of a predetermined total number of objects, one or more of a total number or a frequency of a plurality of objects of the first type of object included in the previous objects.

In some examples, the one or more computing devices can be further configured to determine that the first object is the first type of object based on at least one of the total number or the frequency exceeding a threshold value.

In some examples, the one or more computing devices can be further configured to: obtain, using one or more of the symbol scanner, a dimensioner, or an imaging device, a characteristic of the first object as the first object moves within the transport system; and determine that the first object is the first type of object based further on the characteristic of the first object. The dimensioner can be configured to obtain dimensional data of the objects within the transport system.

In some examples, the runtime data can include a criterion that corresponds to the characteristic, the criterion being based on a characteristic of previous objects processed by the sorting. The one or more computing devices can be configured to determine that the first object is a first type of object, based on the characteristic of the first object satisfying the criterion.

In some examples, the characteristic can include first dimensional data of the first object. The criterion can include a dimensional criterion that is based on dimensional data of the previous objects processed by the sorting.

In some examples, the first dimensional data can include a first dimension. The dimensional criterion can include a dimensional threshold corresponding to the same type of dimension as the first dimension. The one or more computing devices can be configured to determine that the first object is a first type of object by: comparing the first dimension to the dimensional threshold; and based on the first dimension being within the dimensional threshold, determining that the first object is the first type of object.

In some examples, the first dimension is at least one of a height, a length, a width, or a volume.

In some examples, the characteristic can include at least one of a weight, a density, or a symbol characteristic on the first object. The symbol characteristic on the first object can include at least one of a type of the symbol, a pattern of the symbol, a color of the symbol, a size of the symbol, a length of the symbol, a width of the symbol, or an area occupied by the symbol.

In some examples, the characteristic of the first object can include a portion of first symbol information from a first symbol on the first object.

In some examples, the runtime data can include an association of the first symbol information with a second object that is included in the previous objects.

In some examples, the one or more computing devices can be configured to determine an issue classification has occurred for the first object, based on failing to obtain the first symbol information using the symbol scanner. The issue classification for the first object can correspond to a second routing path for the first object within the transport system.

In some examples, the one or more computing devices can be further configured to override the issue classification to control the routing of the first object within the transport system.

In some examples, overriding the issue classification can include at least one of: associating the first symbol information with the first object to control routing of the first object; removing the issue classification for the first object; preventing recirculation of the first object through the transport system; or ignoring the issue classification for the first object relative to travel of the first object through the transport system.

In some examples, a redirection device can be positioned downstream of the symbol scanner, the redirection device being configured to move the objects from a first routing path to a second routing path. The one or more computing devices can be configured to control the routing of the first object by preventing the redirection device from moving the first object to the second routing path, thereby allowing the first object to continue traveling along the first routing path within the transport system past the redirection device, based on the overriding of the issue classification.

In some examples, the issue classification can be a no-read issue classification.

Some examples of the disclosure provide a method of sorting an object. The method can include receiving, using one or more computing devices, runtime information for one or more previous objects processed by a sorting, including a previous object with first symbol information that can indicate a first type of object. The method can include attempting to obtain, using a symbol scanner, symbol information of a first object. The method can include, based on failing to obtain the symbol information, and based on the runtime information, determining that the first object is the first type of object. Routing of the first object within a transport system can be controlled based on determining that the first object is the first type of object.

In some examples, an issue classification can be determined to have occurred for the first object, based on a failure to obtain the symbol information using the symbol scanner. The issue classification can be overridden to control the routing of the first object within the transport system, based on determining that the first object is the first type of object.

In some examples, the characteristic of the first object can include at least one of a dimension of the first object, a weight of the first object, a density of the first object, or a symbol characteristic on the first object. The symbol characteristic on the first object can include at least one of a type of the symbol, a pattern of the symbol, a color of the symbol, a size of the symbol, a length of the symbol, a width of the symbol, or an area occupied by the symbol.

The foregoing and other aspects and advantages of the present disclosure will appear from the following description. In the description, reference is made to the accompanying drawings that form a part hereof, and in which there is shown by way of illustration one or more exemplary versions. These versions do not necessarily represent the full scope of the disclosure.

Some examples of the disclosure provide a system for controlling routing of objects within a transport system that supports and moves objects for routing operations/ One or more computing devices can be configured to communicate with a symbol scanner. The one or more computing devices can be further configured to receive, from the symbol scanner, an image of a symbol positioned on an object within the transport system, and attempt to obtain, from the image of the symbol, symbol information indicating an object type of the object. The one or more computing devices can be further configured to, in response to failing to obtain the symbol information: access runtime data for previous objects that were routed within the transport system before the object; determine, based on the runtime data for the previous objects, that the object is a first type of object associated with first symbol information; and generate, based on determining that the object is a first type of object, a routing command for controlling routing of the object within the transport system.

In some examples, the one or more computing devices can be further configured to: receive from one or more of the symbol scanner, a dimensioner, or an imaging device a characteristic of the object as the object moves within the transport system; and determine that the object is the first type of object based further on the characteristic of the object.

In some examples, the characteristic of the object can include one or more of: a portion of symbol information from a symbol on the object; or dimensional data of the object, wherein the criterion includes a dimensional criterion based on dimensional data of the previous objects processed by the system.

In some examples, the characteristic of the object can include the dimensional data, including a first dimension of the object. The dimensional criterion can include a dimensional threshold corresponding to a same type of dimension as the first dimension. The one or more computing devices can be configured to determine that the first object is the first type of object by: comparing the first dimension to the dimensional threshold; and based on the first dimension being within the dimensional threshold, determining that the object is the first type of object.

In some examples, the one or more computing devices can be further configured to: determine an issue classification occurred for the object, based on failing to obtain the symbol information; and based on determining that the object is the first type of object, override the issue classification by generating the routing command.

### BRIEF DESCRIPTION OF THE DRAWINGS

The following drawings are provided to help illustrate various features of non-limiting examples of the disclosure, and are not intended to limit the scope of the disclosure or exclude alternative implementations.

FIG. 1 shows a schematic illustration of a system for sorting one or more objects that pass by (or through) the system.

FIG. 2 shows a schematic illustration of a sorting system.

FIG. 3 shows a schematic illustration of a sorting system during runtime operations.

FIG. 4 shows a chart of runtime information for five objects that have traveled through a sorting system.

FIG. 5 shows a flowchart of a process for sorting one or more objects.

### DETAILED DESCRIPTION OF THE PRESENT DISCLOSURE

As described above, conventional sorting systems have been proven effective at handling vast numbers of objects-saving considerable time, resources, and cost. However, these sorting systems are not perfect. For example, objects (e.g., packages) that have been flagged with an issue classification are required to be reprocessed (e.g., by recirculating the object, requiring manual intervention of the object, etc.) to be appropriately sorted. This can decrease efficiency of the sorting system (e.g., decreasing object throughput for the sorting system), while also increasing resource demands (e.g., requiring higher manpower costs to effectively deal with the issue classifications for a large number of objects).

A no-read issue classification, unlike other types of issue classifications, almost always requires reworking of the relevant object. For example, a no-read issue classification occurs when symbol information (e.g., a string encoded in a barcode) cannot be fully acquired from a symbol of an object traveling through the object sorting system. Thus, the sorting system, without the symbol information, cannot identify the object. Correspondingly, without an identification, the object cannot be routed accurately, which can require reworking of the object.

No-read classifications can be especially burdensome for sorting systems in some logistical settings. For example, objects without detected symbol information typically must be recirculated (or otherwise reworked). While some issue classifications can be addressed by rescans or mechanical re-positioning of packages, no-read classifications can indicate issues that may require a worker to manually and extensively intervene for these objects. For example, for an object with a missing or unreadable barcode (or other symbol), a worker may need to print and manually apply a label that includes appropriate symbol information (e.g., encoded in a barcode on the label), or manually place the object on a correct routing path.

Some examples of the disclosure provide advantages over conventional approaches relative to these issues (and others) by providing improved systems and methods for sorting objects with issue classifications, and in particular no-read issue classifications (e.g., for objects without scannable symbols, due to damage, missing labels, imaging limitations, or other issues). For example, some implementations of the disclosure provide a sorting system that can effectively recover symbol information for an object in the event that a scan of the object does not provide the symbol information. Generally, examples of the disclosed sorting systems can monitor a series of objects passing through a scanning area (e.g., a scanning tunnel) and identify relevant unique characteristics relative to the series (e.g., a frequency or other count of a particular object or other trends over time, as identified by scanned barcode information). Upon a subsequent object being identified with a no-read (or other) issue classification, the sorting system can identify a likely identification of the subsequent object (e.g., to beyond a threshold confidence value) based on the identified characteristics (e.g., trend patterns).

In some examples, the disclosed sorting systems can be useful in particular for addressing slug flows of particular types of objects (i.e., a sequence of homogenous objects). For example, pallets that arrive at a parcel receiving area (e.g., of a retail store, a warehouse, etc.) are often homogenous. In other words, many pallets include mainly (e.g., mostly or entirely) objects of the same type (e.g., boxes of pet food, boxes of deodorant, other bulk or retail product packages, etc.). Thus, as workers deconstruct a homogeneous pallet by placing the objects on a conveyor of the sorting system, objects from the pallet i.e., objects of the same type-typically move together in a “slug” or series of similar objects (e.g., move together in an extended single file rank along a conveyor). In some examples, a sorting system can identify a slug (e.g., based on reaching a sufficient confidence level) based on identifying a particular count (e.g., a particular frequency or total number over a preset time) of objects of the same type (e.g., objects of the same UPC or other identifier, or otherwise with identical barcode-encoded identifying information). Where a slug is expected, as indicated by the count, a subsequent object that cannot be identified (e.g., due to a classified no-read error) can be identified as being (or as likely being) of the same type as the objects of the slug. This subsequent object may then, for example, be directed according to the identified type rather than being diverted for rescanning or manual intervention.

As a more specific example, as objects travel through a sorting system, runtime information can be obtained, which can include one or more characteristics of the object, successful attempts at acquiring symbol information for an object, unsuccessful attempts at acquiring symbol information for an object, etc. In some cases, the one or more characteristics can include dimensional data of the object (e.g., a length, a width, a height, a weight, a density of the object, etc.), one or more characteristics of a symbol of the object (e.g., a type of the symbol, a pattern of the symbol, a color of the symbol, a size of the symbol, a length of the symbol, a width of the symbol, an area occupied by the symbol, etc.), etc. In some cases, including as further discussed below, characteristic data of an object (e.g., dimensional data) can be used to verify resolution of, or otherwise assist in resolving, no-read or other issue classifications (e.g., by verifying a shape or weight of a no-read object relative to an object type identified via a count of preceding objects).

In some cases, as an object travels through the sorting system, a symbol scanner fails to acquire appropriate symbol information for the object (e.g., receiving a partial barcode string, receiving no barcode string at all, etc.). At this point, the sorting system flags the object as having a no-read issue classification (e.g., which requires reworking of the object). However, when the no-read issue classification is determined for the object, the runtime information can be compared to the one or more characteristics of the first object (or can be utilized in a different manner) to determine that the first object is a specific type of object. For example, because each of these one or more characteristics of the object can be effectively shared with a first type of object (e.g., because the object is in reality a first type of object, such as originating from the same homogeneous pallet), the sorting system can determine that the object is the first type of object based on the comparison. Then, the sorting system can associate the first symbol information with the object, with the first symbol information already being associated with the first type of object. Thus, the sorting system can effectively recover symbol information even when symbol information cannot be fully acquired by scanning the object.

In some configurations, the sorting system can advantageously avoid recirculating the object, even after the object has been determined to have a no-read issue classification. For example, a redirection device can be positioned downstream of a symbol scanner (and a printer) of the sorting system. In this way, the sorting system can, after determining that the first symbol information is associated with the object, allow the object to pass by the redirection device unimpeded (or otherwise, as appropriate). In some cases, this can include, determining that the first symbol information is associated with the object, before the object passes by the redirection device, which can also include causing the printer to print and apply a label on the object that includes the first symbol information (e.g., before the object passes by the redirection device). In this way, the sorting system can not only address the no-read issue classification by sorting the object accurately without scanning the object to obtain the symbol information, but can also print and apply a new label to the object all before the object passes by the redirection device. In some cases, by printing and applying a new label, further downstream issues can be avoided. For example, if the object is scanned again at a location that is downstream of the symbol scanner, a further no-read issue classification can be avoided, with the object being routed according to the scanned symbol information from the new label on the object.

In some examples, rather than using remote computing devices that require substantial time, a computing device that implements computational tasks relative to object sorting can be located within the facility the sorting system is also located within. In addition, a computing device (e.g., the symbol scanner) can leverage another computing device located also within the facility for computational tasks, which can be advantageous because the other computing device can have larger computational and memory resources (e.g., so the symbol scanner does not have to store the database, and may not even be able to, due to the substantially high number of packages).

In some configurations, the symbol scanner (or other computing device) can determine one or more characteristics for objects of a specific type, which can involve using a subset of the packages of the same type, rather than storing and utilizing data from every package of the same type of package seen by the sorting system. For example, the symbol scanner can update the one or more characteristics on a rolling basis using the package of the same type last seen by the sorting system, which can include removing data from a previous package of the same type. In this way, for example the symbol scanner can utilize a moving statistical measure (e.g., average, standard deviation, etc.) of a characteristic (e.g., a dimension), which can be less computationally taxing (or less taxing with regard to memory) than storing data from every single event. In some examples, the symbol scanner (or other computing device) can iteratively update one or more criteria for each of the one or more characteristics for objects of a specific type, using data for a subsequent package that is the same type of package. For example, for a subsequent package that is of the same type of package, a dimension of the subsequent package can be used to update a moving average of the corresponding dimension associated with objects of the first type (e.g., used to determine a dimensional threshold), which can be less computationally taxing (or less taxing with regard to memory), but can also reflect every package of the same type of package (e.g., the historic data for all objects of a particular type can be utilized).

In some examples, utilizing one or more characteristics for recovering symbol information for no-read issue classifications can be especially advantageous in specific applications. For example, when the sorting system processes objects from a homogeneous pallet, the objects typically move single file along a conveyor of the sorting system and the objects are all the same type of object (e.g., for a given run of the conveyor, such as 50 objects that form the homogeneous pallet). Thus, these objects should be substantially (i.e., deviating by less than 10 percent from) the same size (e.g., have the same dimensions), substantially the same weight, substantially the same density, and have substantially the same symbols on the object (e.g., graphics, barcodes, dictatrices, etc.). Accordingly, with relatively low variability between relevant characteristics, a system can associate corresponding symbol information with an object with a no-read issue classification with fairly high confidence, with the certainty increasing, in some cases, as multiple criteria are satisfied for one or more characteristics (e.g., using multiple characteristics).

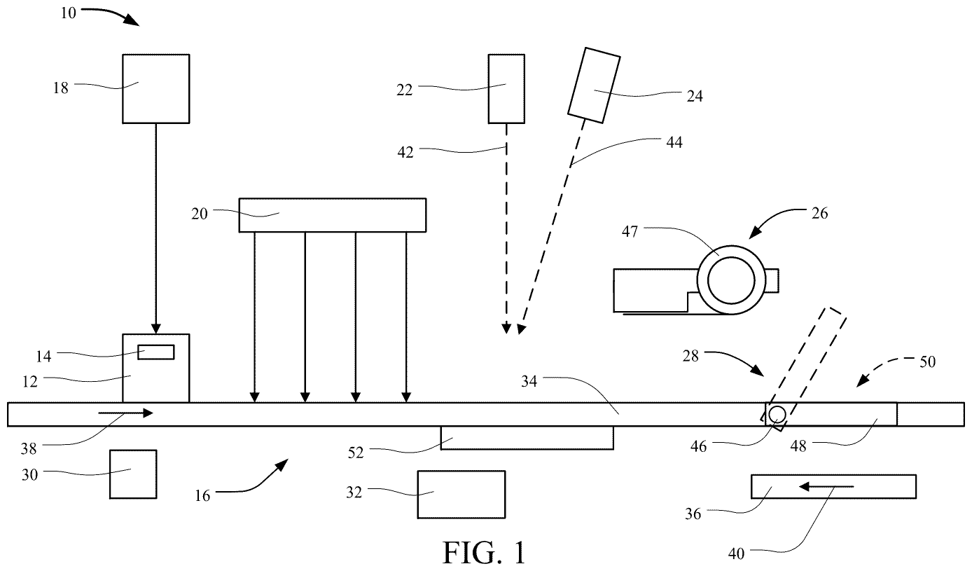

FIG. 1 shows a schematic illustration of a system 10 for analyzing, sorting, etc., one or more objects that pass by (or through) the system 10. For example, the system 10 can acquire one or more images of one or more sides of one or more objects that pass by or through the system 10 (i.e., that are processed by the system 10 for transport). In some cases, the system 10 can evaluate symbols (e.g., barcodes, two-dimensional (2D) codes, etc.) on objects moving through the system 10, such as, for example, evaluating an image of a symbol 14 of an object 12.

In some examples, the symbol 14 can be implemented in different ways. For example, the symbol 14 can be a 1D barcode, a 2D barcode, etc. In some cases, the object 12 (and others that travel through the system 10) can be substantially (i.e., deviating by less than 10 percent from) cuboid. In other cases, however, the object 12 (and others that are moved through the system 10) can have any other suitable geometries. In addition, while the symbol 14 is illustrated as being positioned on a lateral side of the object 12, the symbol 14 can be placed on other sides of the object 12, including, for example, a top side of the object 12.

As shown in FIG. 1, the system 10 can include one or more of a transport system 16, a presence sensor 18, a dimensioner 20, imaging devices 22, 24, a printer 26, a redirection device 28, an encoder 30, and a computing device 32. The transport system 16 can be configured to move objects through the system 10 at a controlled rate, and can be implemented in different ways. For example, the transport system 16 can include one or more conveyors (e.g., conveyor rollers or conveyor belts), one or more movable linkages or arms, one or more motors (e.g., that power and translate linkages or arms), one or more sensors (e.g., an encoder, such as a rotary encoder that sense the speed or other aspects of movement of the transport system 16), one or more robotic arms, etc.

In some cases, the transport system 16 can include a main conveyor (e.g., a conveyor belt) that objects travel along in one direction, and an ancillary (e.g., recirculating) conveyor (e.g., a conveyor belt) that can connect with the main conveyor, in which objects travel along in another direction (e.g., different than the one direction). In this case, for example, objects that travel along the ancillary (e.g., recirculating) conveyor can eventually return to the main conveyor (e.g., at the start or a different location of the main conveyor belt). As shown in FIG. 1, the transport system 16 can include conveyors 34, 36, each of which can move objects in a different direction (and is only partly and schematically shown in FIG. 1). For example, the conveyor 34 can move objects in a direction 38 (e.g., when the objects are supported by the conveyor 34), while the conveyor 36 can move objects in a direction 40 (e.g., when the objects are supported by the conveyor 36) to return the objects to an upstream location on the conveyor 34. In some cases, the direction 38, 40 can be different (e.g., the directions 38, 40 being opposite as shown).

As shown in FIG. 1, the object 12 can be positioned on the conveyor 34 that is configured to move objects in the direction 38 (e.g., a horizontal direction) at a relatively predictable and continuous rate, or at a variable rate measured by a device, such as an encoder (e.g., the encoder 30 or a virtual encoder). In some cases, the conveyor 34 can move one or more objects in other ways (e.g., with non-linear movement). In some configurations, the conveyor 34 can be configured to move one or more objects along the conveyor 34 at speeds of greater than or equal to 1 meter per second (e.g., including less than 3.3 meters per second), which can be faster than the speeds of conveyors in point of sale situations (e.g., conveyors at a kiosk of a retail store). In some configurations, the conveyor can have a width of 3 feet or greater.

In some examples, the presence sensor 18 can detect the presence of the object 12 (or other objects) that travel along the conveyor 34, which can provide an indication for when to acquire one or more images of the object 12 (or otherwise scan the object 12). For example, each imaging device 22, 24 can be configured to obtain one or more images based on a single trigger event, which can be initiated based on a detection of an object by the presence sensor 18. As a more specific example, the detection by the presence sensor 18 can indicate that the object 12 is positioned within a field of view (“FOV”) of each of the imaging devices 22, 24, or can indicate that the object 12 will be within the FOV at a known future time (e.g., as calculated based on encoder information).

The presence sensor 18 can be implemented in different ways. For example, the presence sensor 18 can be a photo eye, an array of photo eyes, a laser curtain, a dimensioner, an imaging sensor, a photoresistor, a phototransistor, a time of flight sensor, etc. In some configurations, the presence sensor 18 can be positioned upstream of each of the imaging devices 22, 24. In this way, when the presence sensor 18 senses the object 12, each imaging device 22, 24 can receive an indication to begin obtaining an image of the object 12 (e.g., after a delay). Thus, the positioning of the presence sensor 18 can help to ensure an image of the object 12 can be obtained, such as due to the delay between sensing the presence of the object 12 and obtaining an image of the object 12. While FIG. 1 illustrates the presence sensor 18 as being separate from the imaging devices 22, 24, in other configurations, the presence sensor 18 can be integrated with one or more of the imaging devices 22, 24. For example, each imaging device 22, 24 can include a presence sensor coupled to (or otherwise integrated within) the respective housing of the imaging device 22, 24. In some examples, a presence sensor can be, or can be included together with, a dimensioner (e.g., a dimensioner configured as discussed below).

In some examples, the dimensioner 20 can be configured to determine dimensional data (e.g., one or more dimensions) of one or more objects (e.g., the object 12), as the one or more objects travel along the transport system 16 (e.g., travel along the conveyor 34). For example, the dimensioner 20 can determine a height, a length, a width, a volume, etc., of each of the one or more objects. In some cases, the dimensioner 20 can be configured to determine a distance from the dimensioner 20 and to a top surface of the object 12, and can be configured to determine a size or orientation of a surface facing the dimensioner 20. In different examples, the dimensioner 20 can be implemented using various technologies. Generally, a dimensioner can be configured according to various known technologies for determining one or more dimensions of an object, including as may be based on imaging technologies, projection technologies, or other approaches known in the art. For example, the dimensioner 20 can be implemented using a 3D camera (e.g., a structured light 3D camera, a continuous time of flight 3D camera, etc.). As another example, the dimensioner 20 can be implemented using a laser scanning system (e.g., a LiDAR system), for example, that uses one or more laser curtains. While the dimensioner 20 is illustrated in FIG. 1 as being separate from the imaging devices 22, 24, in other configurations, one or more of the imaging devices 22, 24 can be (or include) the dimensioner 20.

In some examples, the dimensioner 20 can create a 3D point cloud of the object 12, which can be used to determine the dimensional data (e.g., the volume of the object). In addition, the dimensioner 20 can determine 3D coordinates of each corner of the object 12 in a coordinate space defined with reference to one or more portions of system 10. For example, the dimensioner 20 can determine 3D coordinates of each of eight corners of the object 12 (e.g., that is at least substantially cuboid in shape) within a Cartesian coordinate space defined with an origin at the dimensioner 20. As another example, the dimensioner 20 can determine 3D coordinates of each of a plurality (e.g., four, six, or eight) of corners of the object 12 within a Cartesian coordinate space defined with respect to the transport system 16 (e.g., the conveyor 34, with the Cartesian coordinate space defined with respect to an origin at a center of conveyor 34 in alignment with a particular location relative to the dimensioner 20).

Each imaging device 22, 24 can be implemented using any suitable type of imaging device(s). For example, imaging devices 22, 24 can be implemented using 2D imaging devices (e.g., 2D cameras), such as area scan cameras, line scan cameras, etc. In some examples, each imaging device 22, 24 can include one or more image sensors (e.g., a CCD or CMOS sensor), at least one lens arrangement, at least one control device (e.g., a processor device) configured to execute computational operations relative to the imaging sensor.

In some examples, each imaging device 22, 24 can each include one or more image sensors, at least one lens arrangement, and at least one control device (e.g., a processor device) configured to execute computational operations relative to the image sensor. In some examples, the imaging devices 22, 24 can include or can be associated with a steerable mirror (e.g., as described in U.S. application Ser. No. 17/071,636, filed on Oct. 15, 2020, which is hereby incorporated by reference herein in its entirety). Each imaging device 22, 24 can selectively obtain image data from different fields of view (FOVs), corresponding to different orientations of the associated steerable mirror(s).

In some examples, each imaging device 22, 24 can be positioned at an angle relative to the top side of the conveyor 34 (e.g., at an angle relative to a normal direction of symbols on the sides of the object 12 or relative to the direction of travel provided by the conveyor 34), resulting in an angled FOV, while in other configurations, each imaging device 22, 24 can be positioned substantially perpendicular to a top side of the conveyor 34, a direction of travel provided by the conveyor 34, etc. For example, FIG. 1 shows the imaging device 22 having an optical axis 42 that is substantially perpendicular to the direction 38, and the imaging device 24 having an optical axis 44 that is angled relative to the direction 38. In some cases, including when the imaging devices 22, 24 have a corresponding steerable mirror, the optical axes 42, 44 of the respective imaging device 22, 24 can be when a steerable mirror is in a neutral position. In some configurations, the FOV of the imaging device 22 can overlap with the FOV of the imaging device 24. However, in other configurations, the FOV of the imaging device 22 does not overlap with the FOV of the imaging device 24.

In some examples, the system 10 can be configured to capture one or more images of one or more sides of one or more objects that are moved by the transport system 16 (e.g., the conveyor 34). These captured images can then be used to identify one or more symbols on each object (e.g., the symbol 14), which can be decoded by an appropriate computing device (e.g., by the respective imaging device that obtained the image). In addition, the captured images can be used to determine one or more characteristics of one or more symbols of each object. For example, the captured images can be used to determine a type of a symbol, a size of a symbol, a length of a symbol, a width of a symbol, an area occupied by a symbol, a pattern of a symbol (e.g., including a color pattern of a symbol), etc.

In some configurations, while two imaging devices 22, 24 are illustrated in FIG. 1, the system 10 can include other numbers of imaging devices, such as, for example, a single imaging device, three imaging devices, four imaging devices, etc. In addition, while the imaging devices 22, 24 are illustrated as being positioned above the conveyor 34, each imaging device 22, 24 can be otherwise positioned relative to the conveyor 34 (e.g., below the conveyor 34 and to a side of the conveyor 34).

In some examples, the printer 26 can be configured to print and apply one or more labels on each object as the object travels along the transport system 16 (e.g., travels along the conveyor 34 and past the printer 26), in which each label can include one or more symbols, such as, for example, a barcode (e.g., a 1D barcode, a 1D barcode, etc.). In some cases, the printer 26 can include a label reel 47, which can provide a stock of labels for printing of the one or more symbols on the label prior to the application on the object. In this regard, the printer 26 can include one or more actuators to extend and thus apply a printed label to the object as the object moves along the transport system 16 (e.g., the conveyor 34). For example, as the object 12 travels along the conveyor 34 during runtime, the printer 26 can print a label (e.g., based on a runtime identification of the object 12), and can apply the printed label on a surface of the object 12 as the object 12 moves past the printer 26.

As shown in FIG. 1, the printer 26 can be positioned downstream of the dimensioner 20, and the imaging devices 22, 24, relative to the direction 38. This positioning can be advantageous in minimizing reworking of objects (e.g., objects that are to be manually attended to by a user, including a user printing and manually applying the printed label on the object 12). For example, if an issue with a label can be resolved based on obtaining dimensional data, one or more images, etc. (e.g., as further discussed below) and before the object passing through the printer 26, the printer 26 can print and apply a label to the object as the object passes by the printer 26. In this way, the object may not have to be recirculated, sent to a reworking area, etc., thereby improving efficiency of the system 10. In other words, if the printer 26 was positioned upstream of the imaging devices 22, 24 (and the dimensioner 20), the object must be recirculated in order to print and apply a new label to the object by the printer 26 (e.g., the object must be recognized by the system 10).

In some examples, the redirection device 28 can be configured to redirect one or more objects along a different path of the transport system 16, which can include redirecting one or more objects to a recirculation path of the transport system 16 (e.g., that eventually reconnects with an upstream end of the conveyor 34), a reworking path of the transport system 16 (e.g., in which objects are to be manually reworked), etc. The redirection device 28 can be implemented in different ways. For example, the redirection device 28 can include an actuator that can force an object to be moved off of the conveyor 34 (and onto a different conveyor). For example, as shown in FIG. 1, the redirection device 28 can include a platform 48 coupled to the actuator 46. In this way, if the system 10 determines that the object is to be redirected, the system 10 can cause the platform 48 to move away from the conveyor 34 (e.g., lift upwardly), thereby opening a chute 50 through which the object falls to be redirected for transport by the conveyor 36. In other examples, the actuator 46 can be implemented with other configurations, including in which the actuator 46 can be extended to physically move objects to change a movement path of the object along the transport system 16 (or otherwise redirect the object). For example, the actuator 46 can have a ram that extends to contact an object, pushing the object off the conveyor 34, and onto the conveyor 36.

In some examples, the encoder 30 can be linked to the imaging devices 22, 24, and can determine the amount of travel of the conveyor 34, and the one or more objects supported thereon (e.g., the object 12), over a known amount of time. Thus, signals from the encoder 30 can be used to coordinate capture of images of each object (e.g., the object 12), based on calculated locations of the object relative to a field of view of a relevant imaging device. For example, the encoder 30 can generate an encoder pulse count that can be used to identify the position of conveyor 34 along the direction 38. In particular, the encoder 30 can provide the encoder pulse count to a computing device (e.g., the computing device 32) to identify and track the positions of the one or more objects on the conveyor 34. In some examples, the encoder 30 can increment an encoder pulse count each time conveyor 34 moves a predetermined distance (encoder pulse count distance) in the direction 38. Accordingly, the position of an object can be determined based on an initial position, the change in the encoder pulse count, and the encoder pulse count distance. Then, when the position between the object and the relevant imaging device 22, 24 is determined to be adequate (e.g., below a threshold), the computing device can cause the imaging device 22, 24 to obtain an image of the object.

In some examples, the computing device 32 can be in communication (e.g., bi-directional communication) with some or all of the components of the system 10. Thus, the computing device 32 can coordinate operations of various components of system 10. For example, the computing device 32 can cause the dimensioner 20 to obtain dimensional data of an object supported by the transport system 16, can cause each imaging devices 22, 24 to obtain one or more images of the object (e.g., including a symbol of the object), can cause the printer 26 to print and apply a label that includes a symbol on the object (e.g., as the object moves past the printer 26), can cause the redirection device 28 to redirect the object (e.g., away from the conveyor 34), and can coordinate transfer and storage of data between and among these and other devices. As another example, the computing device 32 can control each steerable mirror of each imaging device 22, 24, receive an indication from the presence sensor 18 (e.g., indicating a trigger event, such as a single trigger event), receive encoder data from the encoder 30, analyze one or more images obtained by the imaging device 22, 24 (e.g., decoding one or more symbols, determining one or more characteristics of the one or more symbols, etc.), etc. In some examples, the computing device 32 can include a user interface (e.g., a touchscreen) to receive various user inputs for control of one or more operations of the system 10.

While not shown in FIG. 1, the system 10 can include one or more illumination sources (e.g., each including an independently controllable light source) to illuminate one or more surfaces of an object, and the computing device 32 can control the operation of the one or more illumination sources (e.g., causing the one or more illumination sources to emit light with particular timing, spatial or color patterns, etc.).

In some examples, the computing device 32 can be in communication with other computing devices (e.g., a server), via, for example, a communication network. In this way, the computing device 32 can receive data from, and transmit data to the other computing devices. For example, the computing device 32 can query a database stored on a different computing device, and can receive data from the computing device.

In some examples, the system 10 can include a scale 52 (or a pressure sensor, force sensor, etc.) that can be configured to weigh each object as each object moves along the conveyor 34. In some cases, the scale 52 can be positioned below the conveyor 34, and the scale 52 can be positioned so that a portion of the scale 52 intersects with a FOV (or optical axis) of one of the imaging devices 22, 24. In this way, during a single trigger event, images acquired for an object that triggers the single trigger event are more likely to be associated with the weight received by the object. In other words, for a single trigger event the object is weighed by the scale at the same time images are acquired of the object. In some cases, including when the dimensioner 20 has determined a volume of an object, the computing device 32 (or other computing device, such as of one of the imaging devices 22, 24) can determine a density of the object using the volume of the object and a weight of the object.

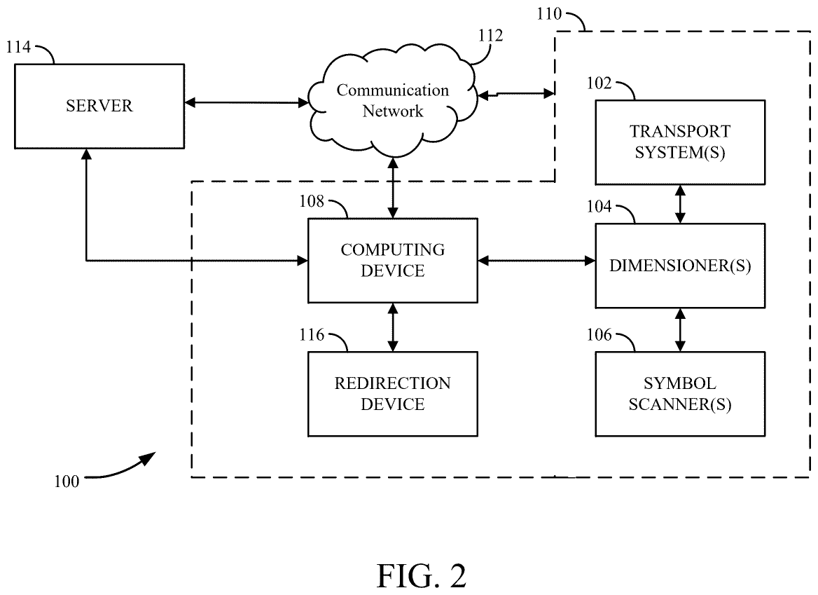

FIG. 2 shows a schematic illustration of a sorting system 100 according to an example of the disclosure. The sorting system 100 can include a transport system 102, a dimensioner 104, a symbol scanner 106 (e.g., a line scan device, an area scan device, or other imaging device according to various known designs), a computing device 108 (e.g., including a memory), and a server 114. The transport system 102, the dimensioner 104, the symbol scanner 106, and the computing device 108 can be situated within a facility 110. In some cases, the facility 110 can be an upstream logistical entity (e.g., a parcel distribution warehouse) that supports downstream logistical entities (e.g., retail stores). The transport system 102, the dimensioner 104, the symbol scanner 106, and the computing device 108 can each be in communication (e.g., local communication, such as over Wi-Fi) with each other. Additionally, as shown, the transport system 102, the dimensioner 104, the symbol scanner 106, the computing device 108, and the server 114 can be in communication with each other, via the communication network 112. Although shown external to the facility 110 in FIG. 2, in some cases either or both of the server 114 and the communication network 112 can be partly or wholly contained by the facility 110. Additionally, in some cases, the computing device 108 (or plurality of computing devices 108) can be partly or wholly contained by the facility 110.

In some examples, the communication abilities of these components can include the transmission (and receiving) of data, instructions, etc., between each other. For example, in some configurations, such as when the computing device 108 is remote to the facility 110, the computing device 108 can receive data from each of the transport system 102, the dimensioner 104, and the symbol scanner 106 and can similarly transmit instructions to cause each of the transport system 102, the dimensioner 104, and the symbol scanner 106 to implement particular functionalities.

In some examples, the computing device 108 can take any of a variety of forms, including traditional computer systems (e.g., a desktop system), mobile devices (including a tablet or a smartphone), generally known general purpose computing systems, hard-wired or other special purpose computing devices, etc. In some examples, the computing device 108 can include or take the form of the Edge Intelligence (EI) platform (e.g., EI-300, EI-700) commercially available from Cognex Corporation in Natick, MA.

In some examples, the transport system 102 supports, moves, and sorts objects to particular intended destinations within a facility. For example, the transport system 102 can receive and translate objects along various paths (e.g., along different conveyor belts), and can control changes to the paths that objects travel along through the facility (e.g., mechanically, with an actuating arm). This adjustment of travel paths or other controlled routing of objects within the facility can adjust the final intended destination or other travel characteristics of the object.

The dimensioner 104 and the symbol scanner 106 can be mounted relative to (e.g., above) the transport system 102 to obtain data of the objects as the objects travel along the transport system 102. For example, the dimensioner 104 can, as the objects travel, obtain dimensional data of these objects. This dimensional data can include the length of an object, the width of an object, the height of an object, the volume of an object, etc. Additionally, the symbol scanner 106, as objects travel, can scan objects to locate and obtain barcode (or other symbol) data.

The dimensional data obtained from the dimensioner 104, and the barcode data obtained from the symbol scanner 106 can be utilized by a computing device (e.g., the computing device 108), collectively or individually, to determine and apply an issue classification for an object. In some examples, the dimensional data obtained by the dimensioner 104 can be used to determine a shape profile of the one or more objects being transported along the transport system 102, the location of the one or more objects relative to a reference location on the transport system 102 (e.g., a centerline of a conveyor), the distance between two packages (e.g., a gap in the direction of travel), a volume of a bounding box that envelopes the one or more objects (e.g., the volume of the 3D shape, such as a rectangular prism, that circumscribes the one or more objects), an actual volume of the one or more objects (or in other words a liquid volume of the one or more objects).

In some examples, the symbol information obtained by the symbol scanner 106 can include, for an event (e.g., as one or more objects travel along the transport system 102), the location on one or more objects for one or more identified barcode (e.g., which side of the object each barcode is located on, and any remaining sides of the one or more objects that do not include a symbol), the total number of symbols identified on the one or more objects, the symbol size for each symbol (e.g., the physical size of the symbol, or the number of pixels per symbol read by the symbol scanner 106), the symbology type of each symbol, the information encoded by each symbol (e.g., a numerical string encoded by a barcode, an alphanumeric string from optical character recognition of the symbol, etc.), the locations of one symbol relative to another symbol (e.g., if more than one barcode is identified), etc.

As generally noted above, in some implementations, certain of the components of the sorting system 100 can each be configured to implement functionality for a particular event. For example, the dimensioner 104 and the symbol scanner 106 can be configured to collectively operate during a single event to identify dimensional data and barcode information for a particular object that is moving through a particular area (or areas) of the transport system 102. In some cases, multiple operations can be implemented based on a single trigger. For example, the dimensioner 104 and the symbol scanner 106 can be configured to operate in concert (e.g., simultaneously or in sequence) to obtain dimensional data and barcode information for a particular object based on the object passing an optical eye or other presence sensor or based on encoder-based or virtual tracking of an object through the transport system 102 that provides a common trigger for these (and potentially other) operations.

In some examples, the sorting system 100 can include a redirection device 116, which can be in communication with some or all of the components of the sorting system 100. For example, the redirection device 116 can be in communication with the computing device 108, the server 114 (e.g., via the communication network 112), the symbol scanner(s) 106, etc. The redirection device 116 can be implemented in different ways, including those described with reference to the other redirection devices herein. For example, the direction device 116 can include an actuator that can be configured to move an object from a first routing path of the transport system(s) 102 to a second routing path of the transport system(s) 102 different than the first routing path (e.g., in response to a particular routing command). In this way, the computing device 108 (or another computing device) can cause the actuator to move (e.g., by contacting) the object from the first routing path to the second routing path.

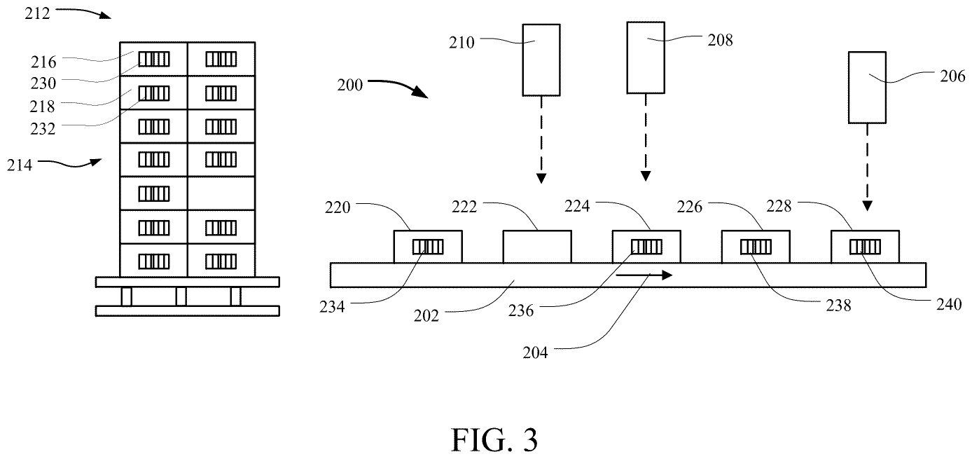

FIG. 3 shows a schematic illustration of a sorting system 200, which relates to the other sorting systems described herein. Thus, the description of the sorting system 200 pertains to the other sorting systems described herein (and vice versa). The sorting system 200 can include a conveyor 202 (or other known transport system) that is configured to support and move objects in a direction of travel 204, and a symbol scanner 206 (e.g., an imaging device) that can be positioned above or otherwise relative to the conveyor 202 (or other transport system) to scan the one or more objects to acquire respective symbol information as the one or more objects move along the conveyor 202. For example, the symbol scanner 206 can be configured to acquire one or more images of an object (e.g., as the object moves along the conveyor 202), identify one or more symbols within the one or more images, and attempt to decode identified symbols from the one or more images to determine symbol information for the object (e.g., identification of an object type, as may be associated with a particular object routing). In this way, the symbol scanner 206 can determine symbol information for the object for which the one or more images are acquired.

In some cases, however, the symbol scanner 206 fails to obtain symbol information from an object (e.g., as the object moves along the conveyor 202). For example, this can include the symbol scanner 206 failing to acquire any symbol information at all, which can be due to the object lacking any symbol altogether, or the object having one or symbols that are damaged. As another example, this can include the symbol scanner 206 failing to acquire symbol information that is sufficient to identify the object as being a particular type of object. For example, the symbol scanner 206 can acquire, using the symbol scanner, partial symbol information, but can still “fail” to acquire symbol information within the context of object sorting operations. In other words, the partial symbol information (e.g., a portion of a UPC) can be insufficient to properly identify the object as being a particular type of object (e.g., the UPC). Regardless of the configuration, the symbol scanner 206 (or other computing device) can determine, based on failing to obtain symbol information for the object, that an issue classification has occurred for the object, which can be a no-read issue classification. In some cases, the no-read issue classification can be indicative of the inability to acquire symbol information that indicates that the object is a particular type of object or that otherwise identifies the object for a particular operational routing.

In some examples, when the symbol scanner 206 fails to obtain symbol information for an object, the object is required to be reworked, which as described above, increases inefficiencies for the sorting system 200 (e.g., by requiring a user to manually intervene). However, in some scenarios, including during processing of homogeneous pallets in which the objects that form the homogeneous pallet are all the same type of object, the confidence that any one object is the same type as other objects during a period of time of operation of the sorting system 200 may be relatively high. Thus, runtime data of one or more objects that were processed by the sorting system can be advantageously used to more efficiently handle issue classifications including no-read issue classifications.

For example, FIG. 3 shows a homogenous pallet 212 that includes a plurality of objects 214 that are the same type of object (e.g., a first type of object), and one or more objects that originate from the homogeneous pallet 212 (e.g., were manually loaded in sequence from the pallet 212). In particular, the plurality of objects 214 include objects 216, 218, and the one or more objects originating from the homogenous pallet 212 include objects 220, 222, 224, 226, 228. While the homogeneous pallet 212 has been illustrated to show 14 objects, it is appreciated that the homogenous pallet 212 can include greater (or less) numbers of the same object, such as, for example, 50 objects, 100 objects, etc.

As shown in FIG. 3, each object originating from the homogenous pallet 212 is the same type of object, and thus each of these objects share certain characteristics. These shared characteristics can include a distance dimension (e.g., width, height, length, volume, etc.), a weight, a density, etc. In addition, these characteristics can also relate to symbols on the objects (assuming a given object includes a symbol). For example, each of the objects 216, 218, 220, 224, 226, 228 can include a respective symbol 230, 232, 234, 236, 238, 240 that is the same. Thus, the characteristics of the symbols can be the same, which can be a type of a symbol (e.g., a 1D symbol such as a barcode, a 2D symbol such as a data matrix, etc.), a pattern of a symbol (e.g., an outline of a portion of the symbol), a color of a symbol, a size of a symbol, a length of a symbol, a width of a symbol, an area occupied by a symbol, etc. Accordingly, because these characteristics are shared by the all the objects originating from the homogeneous pallet 212 (e.g., because they are the same type of object that is designated by the same symbol information, such as, for example, a UPC), these characteristics can be used to inform assessments of unknown objects (e.g., to determine that an object is a particular type of object), and can thus be used to more efficiently handle issue classifications including no-read issue classifications.

In some configurations, while the symbols 230, 232, 234, 236, 238, 240 are illustrated as being barcodes that encode the symbol information (e.g., a string, an alphanumeric string, a numeric string, a UPC, a global trade item number (“GTIN”), a global standard number), in other configurations, the symbols 230, 232, 234, 236, 238, 240 can be implemented in different ways. For example, the symbols 230, 232, 234, 236, 238, 240 can be the same graphic (e.g., a trademark, a brand label, etc.), one or more of the same characters (e.g., an alphanumeric string on each object, a numeric string on each object, etc.), a direct part marking (“DPM”), etc. Correspondingly, the symbol information obtained from an object can be a string (e.g., by optical character recognition (“OCR”) of the string on the object), an image (e.g., of the same symbol), etc.

In some examples, the sorting system 200 can include a dimensioner 208 that can be positioned above the conveyor 202, and an imaging device 210 or other symbol scanner that can be positioned above the conveyor 202. The imaging device 210 can be configured to acquire one or more images of each object, as, for example, each object moves along the conveyor 202, while the dimensioner 208 can be configured to acquire dimensional data of each object, as, for example, each object moves along the conveyor 202. In some configurations, while the sorting system 200 is illustrated as having the symbol scanner 206, the dimensioner 208, and the imaging device 210 all be separate components, in other configurations, one or more of these can be integrated as appropriate. For example, in some configurations, the symbol scanner 206 can be an imaging device that can also function as a dimensioner. In particular, the symbol scanner 206 can acquire one or more images of each object, and can use the one or more images to determine dimensional data for each object (e.g., a width of the object, a length of the object, a height of the object, a volume of the object, etc.).

Regardless of the possible variations in configuration noted above, the sorting system 200, and in particular, the symbol scanner 206, the dimensioner 208, the imaging device 210, etc., can generally be configured to obtain runtime data of one or more objects that travel along the sorting system (e.g., the one or more objects having been processed by the sorting system). This runtime data can then be used advantageously to identify an object as being of a particular type of object, and can advantageously address issue classifications (e.g., no-read issue classifications) for an object.

In some configurations, homogenous pallets can be deconstructed and processed serially. In other words, objects that from a homogenous pallet are all placed on the conveyor 202 before objects from a different homogenous pallet are placed on the conveyor. In addition, objects from a homogenous pallet can be placed on the conveyor 202 so that they are in a single file. As shown in FIG. 3, objects from the homogenous pallet 212, including the objects 220, 222, 224, 226, 228, are placed on the conveyor 202, until, for example, all the objects from the homogenous pallet 212 have been removed from the homogenous pallet 212 (e.g., leaving the supporting pallet). Then, the sorting system 200 can obtain runtime data for transport of these objects, including obtaining symbol information (if possible) and one or more characteristics of each of the objects 220, 222, 224, 226, 228 as the objects travel along the conveyor 202. For example, the symbol scanner 206 can acquire symbol information from each symbol of each object (e.g., by using an image of the symbol and decoding the image of the symbol to extract the symbol information encoded in the symbol). As another example, the dimensioner 208 can acquire one or more characteristics of each object that is dimensional data of each object, or the imaging device 210 can acquire one or more characteristics of each symbol of each object (e.g., an area of the symbol, a pattern of the symbol, a type of the symbol, etc.).

In some examples, the sorting system can obtain runtime data that indicates a count of a particular object type or other object characteristic relative to a particular interval (e.g., total number of scans, total amount of time, total number of objects of a certain type, etc.), or other temporal pattern. For example, obtained runtime data can be a frequency of objects having first symbol information (e.g., a first UPC) during a period of time the sorting system operates (e.g., before a subsequent object is processed by the sorting system), a number of objects having first symbol information over a predetermined time interval or an interval corresponding to a total number of objects processed by the sorting system 200, etc. As another example, the runtime data can be a dimension of one or more of the objects (e.g., a width), can be a characteristic of a symbol of one or more objects (e.g., an area in which the symbol spans on the object), etc.

In some configurations, and as described in more detail below, the runtime data can include, or can be used to determine one or more criteria corresponding to the one or more characteristic. For example, the one or more criteria can include one or more thresholds for each characteristic. As a more specific example, the one or more criteria can include a dimensional threshold (e.g., a length threshold) for a dimension (e.g., the length). In some cases, the one or more criteria (e.g., a threshold) can be updated for each new object processed by the sorting system (e.g., after the one or more characteristics have been obtained by the sorting system for the new object). For example, in this case, a characteristic (e.g., a width) for the new object can be used to update the threshold, by, for example, including the characteristic in a running average of the same characteristic, including the characteristic in a running standard deviation of the same characteristic (e.g., with the standard deviation defining the range of the threshold), etc.

In some examples, historical runtime data can be used to accurately associate symbol information with objects from which the symbol information has not been directly obtained, as can be used to accurately address no-read and other issue classifications for objects. For example, as shown in FIG. 3, the symbol scanner 206 can obtain first symbol information from each symbol 236, 238, 240 of each object 224, 226, 228, and other characteristics of these objects 224, 226, 228 as each object travels along the conveyor 202. In some cases, because the first symbol information has been obtained for each of the objects 224, 226, 228, each of these objects 224, 226, 228 can be routed accordingly (e.g., according to a first routing path within the transport system 200). In other words, because the first symbol information has been obtained for each of the objects 224, 226, 228, each of these objects 224, 226, 228 have been determined to be a first type of object, and thus can be routed accordingly.

However, as the object 222 travels along the conveyor 202, the symbol scanner 206 is unable to acquire first symbol information from the object 222 because the object 222 lacks a symbol that includes the first symbol information (e.g., or a symbol on the object 222 that includes the first symbol information is damaged). In this case, the sorting system 200 (e.g., the symbol scanner 206) can determine an issue classification for the object 222 (e.g., a no-read issue classification, based on failing to obtain the first symbol information for the object 222) that can be associated with a second routing path for the object 222 within the transport system 200 that is different from the first routing path (e.g., a reworking path). Instead of routing the object 222 on this basis, the sorting system 200 can instead determine, using the runtime information, that the object 222 is the same (e.g., first) type of object as the objects 220, 222, 224, 226, 228. In this way, the sorting system 200 (e.g., the symbol scanner 206) can control routing of the object 222 within the sorting system 200, based on determining that the object 222 is the first type of object. In addition, in some cases, the sorting system 200 can associate the first symbol information with the object 222, and can print and apply a label on the object 222 that includes the first symbol information.

In some examples, the runtime information can include symbol information for each of the objects in which symbol information was successfully obtained (e.g., by the symbol scanner 206). For example, the runtime information can include first symbol information for the object 224 (or the object 220) that is positioned downstream (or upstream) of the object 222, or for a plurality of generally adjacent objects (e.g., the objects 224, 226, 228 downstream of the object 222, and the object 220 upstream of the object 222). In this way, the sorting system 200 can determine that the object 222 is a first type of object, based on first symbol information obtained from the object 224 (or other combination of the objects 224, 226, 228, 220, etc.) and the runtime pattern of object types identified for the objects collectively (e.g., count information for the objects 224, 226, 228 as noted above). In some cases, such inferred association between the no-read object 222 and the shared symbol information encoded by the symbols 236, 238, 240 can be made with relatively high confidence, including because the likelihood that the objects 222, 224 are of the same type is high for processing of objects from a homogenous pallet, as illustrated.

As another example, the runtime information can include first symbol information for each object 220, 224. In this way, the sorting system 200 can determine that the object 222 is a first type of object, based on the first symbol information obtained from the object 224, and the first symbol information obtained from the object 220 at least because the likelihood that the object 222 is a first type of object that is designated by the first symbol information is even higher when the object 224 that is downstream of the object 222 and the object 220 upstream of the object 222 both have the first symbol information.

As yet another example, the runtime information can include first symbol information for each object 220, 224, 226, 228 (and one or more other objects upstream of the object 222). In this way, the sorting system 200 can determine that the object 222 is a first type of object, based on the first symbol information obtained from the objects 220, 224, 226, 228, at least because the likelihood that the object 222 is a first type of object is yet even higher when an object (e.g., the object 220) that is positioned upstream of the object 222 has first symbol information and one or more other objects positioned upstream or downstream of the object 222 also have first symbol information. In some cases, multiple objects that have first symbol information and are positioned upstream of the object 222 can indicate (e.g., to the sorting system 200) that there are still objects originating from the homogenous pallet 212 on the conveyor 202. In other words, for example, that one or more objects from a different homogenous pallet are not adjacent to the object 222, or that all the objects originating from the homogenous pallet 212 have not yet been processed.

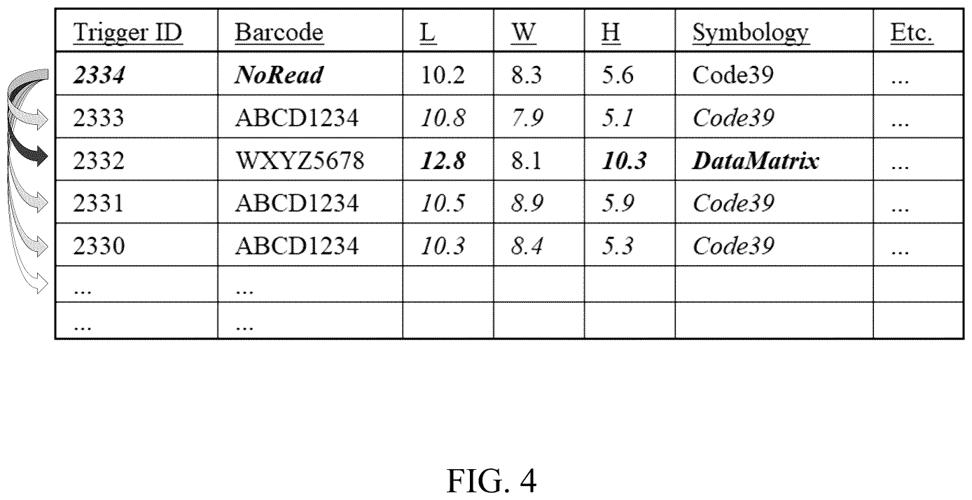

FIG. 4 shows a chart of runtime information for five objects that have traveled through a sorting system (e.g., the sorting system 200). Each of the five objects have a respective trigger identification (e.g., a trigger identification number to identify the object or objects captured during a single trigger event), and each of the five objects have symbol information (e.g., barcode information) for each trigger identification (if the symbol information was acquired), and characteristics including length, width, height, symbology (e.g., the type of symbol), etc. As shown in FIG. 4, the trigger identification “2334” in the first row appeared as a no-read issue classification. However, the other characteristics of the object with the trigger identification “2334” are consistent with each type of characteristics for the trigger identification “2333,” “2331,” and “2330.” For example, the length of the object in the first row has substantially the same length, substantially the same width, substantially the same height, and has the same type of symbol. (As used herein, “substantially the same” indicates a deviation of less than 10 percent from a reference value.) Thus, in this case, a sorting system can route the object with the trigger identification “2334” according to the fist symbol information (here “ABCD1234”) that is shared by each of the objects with the trigger identifications “2333,” “2331,” and “2330.” In addition, the sorting system can associate the first symbol information with the object in the first row (e.g., including the trigger identification), while maintaining that a no-read issue classification occurred for this object.

Although a correspondence between all four of the characteristics of length, width, height, and symbology are illustrated in the example of FIG. 4, other examples may identify correspondence between different characteristics (e.g., only select dimensions, only symbology, only weight or density, or various combinations thereof).

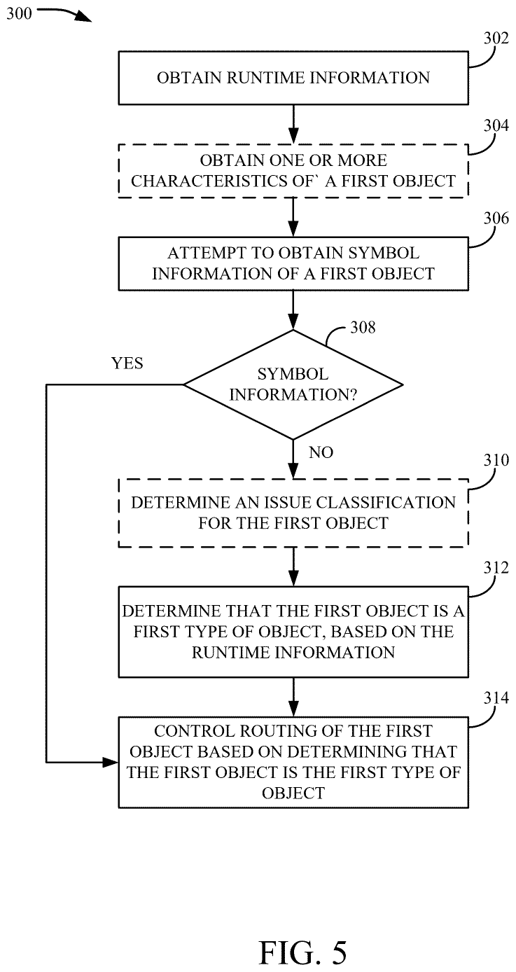

FIG. 5 shows a flowchart of a process 300 for sorting one or more objects, which can be implemented using any of the sorting systems described herein. In addition, the process 300 can be implemented using one or more computing devices, as appropriate. In some examples, the process 300 can be implemented via a computer-implemented method (e.g., a downloadable or otherwise accessible software application (“app”)) using one or more computing devices (e.g., computing device 108).

At 302, the process can include a computing device obtaining runtime information, (e.g., of the various types of runtime information described above). For example, the runtime information can include symbol information obtained for one or more objects being processed by a sorting system, and can include one or more characteristics obtained for the one or more objects. In some cases, the runtime information can include one or more criteria (e.g., a threshold) associated with one or more of the obtained characteristics. For example, the runtime information can include a dimensional threshold (e.g., a range), which can be a length threshold, a width threshold, a height threshold, a volume threshold, etc. As another example, including when the runtime information includes symbol information obtained for the one or more objects of the sorting system, the runtime information can include a total number of the one or more objects having the first symbol information over a predetermined period of time (e.g., of operation of the sorting system), or for a predetermined number of the one or more objects (e.g., a subset of the one or more objects, which can include a running average), a frequency of the one or more objects having the first symbol information relative to the number of the one or more objects over a predetermined period of time, or for a predetermined number of the one or more objects, or other count over a relevant interval, etc.

In some examples, the runtime information can include a user input. For example, the user input can indicate that the sorting system is to receive a number of objects that are the same type (e.g., and thus have the same designated symbol information). Thus, the sorting system can advantageously, after receiving the user input, determine that all of the subsequent objects are a first type of object, and thus should be routed, treated, etc., accordingly.

At 306, the process 300 can include a computing device obtaining one or more characteristics of a first object (e.g., as the object moves along a conveyor of the sorting system), in which the first object can be different than the one or more objects at the block 302. In some cases, the one or more characteristics can include dimensional data of the first object, a weight of the first object, a density of the first object, one or more characteristics of a symbol of the first object. For example, the dimensional data can include a width of the first object, a length of the first object, a height of the first object, a volume of the first object, etc. As another example, the one or more characteristics of the symbol of the first object can include a type of the symbol (e.g., the symbology of the symbol), a size of the symbol, a length of the symbol, etc.

At 306, the process 300 can include a computing device attempting to obtain symbol information of a first object (e.g., with the first object being different than the one or more objects indicated at the block 302), in which the symbol information can indicate an object type of the first object. In some cases, the computing device (e.g., of a symbol scanner) can attempt to obtain symbol information from the first object as the first object travels along a conveyor of a sorting system. In some cases, this can include a computing device obtaining the symbol information (e.g., a UPC) that corresponds to a symbol of the first object, which is sufficient to indicate an object type for the first object. In other cases, this can include a computing device obtaining partial symbol information from the first object (e.g., corresponding to a symbol of the first object), which is insufficient to indicate an object type for the first object. For example, the partial symbol information can include a few characters, but not enough characters to indicate the object type of the first object.

At 308, the process 300 can include a computing device determining whether or not symbol information has been acquired for the first object sufficient to control routing of the object accordingly (e.g., symbol information designating the object type for the first object). If at the block 306, a computing device determines that the symbol information has been acquired, the process 300 can proceed to the block 312, which can include a computing device processing the first object based on the symbol information (e.g., as may correspond to determining that the first object is a first type of object). In some cases, then, a computing device can determine that the first object is a first type of object based on the presence of the symbol information.

If, however, at the block 306, a computing device determines that the attempt to obtain symbol information at the block 304 has failed (e.g., in other words a computing device has failed to obtain appropriate symbol information at the block 304), the process 300 can proceed to the block 308. For example, a sorting system may identify at the block 306 that a no read issue classification applies to an object that was scanned for barcode information at the block 306, based on a failure to identify relevant (e.g., complete) barcode information for identifying and routing the object.

Correspondingly, at 310, the process 300 can include a computing device determining an issue classification for the first object (e.g., an issue classification has occurred for the first object), which can be based on the failure to obtain the symbol information from the first object at the block 306. In some cases, the issue classification can be a no-read issue classification, which can be indicative of failure to acquire the symbol information that is sufficient to identify a type of object for the first object. In some cases, operations at block 306 can automatically follow or be integrally incorporated into analysis at the block 308 regarding whether relevant symbol information has been identified.

At 312, the process 300 can include a computing device determining that the first object is a first type of object, based on the runtime information for one or more objects processed by the sorting system (e.g., in which the phrase having been processed can include obtaining information for the one or more objects, including, for example, symbol information, one or more characteristics, etc.). In some cases, this can include a computing device comparing a count of objects (e.g., a total number or frequency of objects) in which symbol information has been obtained for each of the objects (e.g., with the symbol information being sufficient for identifying an object type for the respective object) for a predetermined period of time of operation of the sorting system, for a predetermined number of objects (e.g., in which the number of objects is a subset of the predetermined number of objects, etc.) seen by the sorting system (e.g., last seen), to a threshold value. Correspondingly, a computing device can determine that the object is a first type of object, based on the number of objects (or frequency of objects) exceeding the threshold value. In this way, for example, the sorting system can determine that an object originating from a homogenous pallet likely has the same symbol information as the other objects seen by the sorting system during a (short) period of operation of the sorting system (or for the small number of objects, such as five objects, last seen by the sorting system). As also noted above, in other implementations, other analysis of runtime information to assess a no-read object is also possible.

In some examples, and as described above, a computing device can acquire partial symbol information from the first object (e.g., a first symbol of the first object), which is insufficient to determine an object type of the first object. However, the partial symbol information can, in some cases, be useful for ultimately determining that the first object is the first type of object. For example, the partial symbol information can be compared to the symbol information of the runtime information for one or more objects processed by the sorting system (e.g., the one or more objects being upstream of the first object, downstream of the first object, or both). Then, a computing device can determine that the first object is the first type of object, based on the partial barcode information being the same as a portion of the symbol information of the one or more objects that were assessed at the blocks 302, 304.

In some examples, the block 312 can include a computing device determining that the object is the first type of object, based on the one or more characteristics of the first object. For example, the runtime information can include one or more criteria for one or more characteristics (e.g., in which each characteristic corresponds to the same criteria type of the one or more characteristics of the first object). In this way, a computing device can determine that the first object is the first type of object, based on the one or more characteristics of the first object satisfying the one or more criteria. As another specific example, the one or more characteristics of the first object can include first dimensional data, and the runtime information can include one or more dimensional criteria. In this case, a computing device can determine that the first object is the first type of object, based on the first dimensional data satisfying the one or more dimensional criteria.

In some configurations, each criterion for a corresponding (e.g., each) characteristic can include a threshold (e.g., a characteristic that is a dimension can include a dimensional threshold, a characteristic that is a weight can include a weight threshold, etc.). In this way, each of the one or more characteristics of the first object can be compared to each corresponding threshold. For example, when a characteristic is a first dimensional threshold for a first type of dimension (e.g., a width), and when the one or more characteristics of the first object includes a first dimension that is the same type as the first type of dimension (e.g., the first dimension is a width), a computing device can compare the first dimension to the first dimensional threshold. Then, a computing device can determine that the first object is the first type of object, based on the first dimension being within the first dimensional threshold.

In some configurations, the evaluation of more than one of the characteristics can increase the confidence of a determination that the first object is the first type of object, including as initially determined based on a count of objects of the first type and verified by analysis of dimensional data. In some cases, one characteristic may be more relevant to identification of an object type than a different characteristic. For example, a dimension can be more relevant of the object type, than, for example, a size of a symbol, which alone may not definitively tell the type of object (e.g., multiple different types of objects can have the same type of symbol). In this case, however, one or more characteristics can be evaluated to determine one or more confidence values for the first object that is indicative of the confidence the first symbol information is associated with the first object (e.g., or in other words the confidence that the first object is actually the first type of object). For example, a computing device can determine a first confidence value for the first object, based on a first characteristic of a first type (e.g., length) of the first object satisfying (or not satisfying) the corresponding one or more criteria of the first type of characteristic (e.g., a length threshold).

Correspondingly, a computing device can determine a second confidence value for the first object, based on a second characteristic of a second type (e.g., a symbol size) of the first object satisfying (or not satisfying) the corresponding one or more criteria of the second type of characteristic (e.g., a symbol size threshold), in which the first type of characteristic is different than the second type of characteristic. This evaluation can be used to determine a confidence value for each type of criterion. Then, the multiple different confidence values can be combined to generate another confidence value (e.g., a combined confidence value). For example, a computing device can determine that a confidence value is positive, based on the characteristic satisfying the one or more criteria (e.g., providing information consistent with the object being a specific type of object), whereas a computing device can determine that a confidence value is negative, based on the characteristic not meeting (e.g., exceeding) the one or more criteria (e.g., providing information that is not consistent with the object being the specific type of object).

In addition, as described above, some characteristics can be more relevant to the identity of an object than others. In this case, the magnitudes of some confidence values can be greater than others, with higher confidence value magnitudes being tied to a greater confidence that the object is consistent with the object of the specific type. Regardless, a computing device can combine the one or more confidence values (e.g., by adding the confidence values together) to generate another confidence value (e.g., a combined confidence value). In this way, a computing device can determine that the first object is the first type of object, based on a confidence value (e.g., the combined confidence value) exceeding a threshold value, which can effectively utilize more than one characteristic to determine the identity of the first object.

At 314, the process 300 can include a computing device control routing of the first object, based on determining that the first object is the first type of object. For example, this can include a computing device associating the first symbol information with the first object, and using the first symbol information associated with the first object to route the first object (e.g., within the transport system). In some configurations, this can include moving the first object to a different second routing path within the transport system that is different than a first routing path of the transport system (e.g., with the second routing path being for objects that cannot be identified as being of a particular type of object, such as those having insufficient symbol information to properly identify the object type). For example, a computing device can cause a redirection device (e.g., an actuator) to move (e.g., physically move by contacting the first object) the first object off a first conveyor (e.g., defining the first routing path) to a second conveyor (e.g., defining the second routing path, which can be a recirculation path).

In other configurations, this can include allowing the first object to move along a first routing path (e.g., with the first routing path being for objects that can be identified, such as those having symbol information associated therewith sufficient for identifying the object as being a specific type of object), and preventing the first object from moving to a second routing path (e.g., with the second routing path being for objects that cannot be identified as being of a particular type of object, such as those having insufficient symbol information to properly identify the object type). In some configurations, this can include preventing the first object from being recirculated through the transport system (e.g., based on the first object being determined to be the first type of object).

In some examples, the block 314 of the process 300 can include a computing device overriding the issue classification (e.g., determined at the block 310) to control routing of the first object within the transport system (e.g., based on the first object being determined to be the first type of object). In some cases, overriding the issue classification can include associating the first symbol information with the first object to control routing of the first object, removing the issue classification for the first object (e.g., after the issue classification has been associated with the first object), preventing recirculation of the first object through the transport system, (generally) ignoring the issue classification for the first object (e.g., relative to travel of the first object through the transport system), etc.

In some examples, the block 314 of the process 300 can include a computing device associating the first symbol information with the first object (e.g., based on the first object having been determined to be the first type of object). In some examples, this can include a computing device printing (and applying) a label on the first object, as the first object passes by the printer (e.g., in which the printer is positioned upstream of a redirection device, a second path routing path, etc.). In this way, the label that includes the first symbol information (e.g., encoded with the first symbol information) can be applied to the first object, which can mitigate issues downstream in the logistics network.

In some examples, operations after the block 314 (or at a different location in the process flow) can include updating relevant one or more criteria (e.g., a threshold) using the one or more characteristics, updating the runtime data (e.g., the number of objects in which symbol information is sufficient to indefinity an object is a particular type of object), or otherwise using the one or more characteristics (or other data of the any of the other blocks, such as the blocks 306, 308, 310, etc.) for training of the sorting system (e.g., to create or further refine dimensional databases, dimensional or other criterion, etc.). Thus, the data for each object processed by the sorting system can be used to train the sorting system, as appropriate.

The present disclosure has described one or more preferred examples, and it should be appreciated that many equivalents, alternatives, variations, and modifications, aside from those expressly stated, are possible and within the scope of the disclosed technology.

It is to be understood that the disclosure is not limited in its application to the details of construction and the arrangement of components set forth in the accompanying description or illustrated in the accompanying drawings. The disclosure is capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular examples or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or examples. Further, references to particular rotational or other movements (e.g., counterclockwise rotation) is generally intended as a description only of movement relative a reference frame of a particular example of illustration.

In some examples, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, examples of the disclosure can be implemented as a set of instructions, tangibly embodied on a non-transitory computer-readable media, such that a processor device can implement the instructions based upon reading the instructions from the computer-readable media. Some examples of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the disclosure. Further, in some examples, certain operations can be executed in parallel, including by dedicated parallel processing devices, or separate computing devices configured to interoperate as part of a large system. Similarly, unless specifically indicated, ordinal labels (e.g., first, second, etc.) are used for convenience based on the order of presentation of the relevant components or operations and are not intended to indicate a required order or correspondence (e.g., with a first “A” necessarily corresponding to a first “B”).

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as examples of the disclosed technology, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of,” or “exactly one of.”

This discussion is presented to enable a person skilled in the art to make and use examples of the disclosure. Various modifications to the illustrated examples will be readily apparent to those skilled in the art, and the generic principles herein can be applied to other examples and applications without departing from the principles disclosed herein. Thus, examples of the disclosure are not intended to be limited to examples shown, but are to be accorded the widest scope consistent with the principles and features disclosed herein and the claims below. The accompanying detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features of the disclosure are presented in the following claims, with corresponding advantages.

1. A system for controlling routing of objects within a transport system that supports and moves objects for routing operations, the system comprising:
a symbol scanner configured to scan a symbol of each of the objects to obtain corresponding symbol information as the objects move within the transport system;
one or more computing devices in communication with the symbol scanner the one or more computing devices being configured to:
obtain runtime data for previous objects that were processed by the system before a first object
obtain, using one or more of the symbol scanner, a dimensioner, or an imaging device, a characteristic of the first object as the first object moves within the transport system, the dimensioner configured to obtain dimensional data of the objects within the transport system;
attempt to obtain, using the symbol scanner symbol information on the first object as the first object moves within the transport system, the symbol information indicating an object type of the first object;
in response to failing to obtain the symbol information, determine, based on the runtime data for the previous objects and the characteristic of the first object, that the first object is a first type of object associated with first symbol information; and
control routing of the first object within the transport system based on determining that the first object is the first type of object,
wherein the runtime data includes a criterion corresponding to the characteristic of the first object, the criterion being based on a characteristic of the previous objects processed by the system, and
wherein the one or more computing devices are configured to determine that the first object is the first type of object, based on the characteristic of the first object satisfying the criterion.

2. The system of claim 1, wherein the runtime data indicates, for one or more of a predetermined period of time or a processing by the transport system of a predetermined total number of objects, one or more of a total number or a frequency of a plurality of objects of the first type of object included in the previous objects.

3. (canceled)

4. (canceled)

5. The system of claim 1, wherein the characteristic of the first object includes one or more of:
a portion of first symbol information from a first symbol on the first object; or first dimensional data of the first object, wherein the criterion includes a dimensional criterion that is based on dimensional data of the previous objects processed by the system.

6. The system of claim 5, wherein the characteristic of the first object includes the first dimensional data, including a first dimension of the first object
wherein the dimensional criterion includes a dimensional threshold corresponding to a same type of dimension as the first dimension, and
wherein the one or more computing devices are configured to determine that the first object is the first type of object by:
comparing the first dimension to the dimensional threshold; and
based on the first dimension being within the dimensional threshold,
determining that the first object is the first type of object.

7. The system of claim 1, wherein the characteristic of the first object includes at least one of a weight, a density, or a symbol characteristic on the first object that includes at least one of a type of the symbol, a pattern of the symbol, a color of the symbol, a size of the symbol, a length of the symbol, a width of the symbol, or an area occupied by the symbol.

8. The system of claim 1, wherein the runtime data includes an association of the first symbol information with a second object that is included in the previous objects

9. The system of claim 1, wherein the one or more computing devices are configured to determine an issue classification has occurred for the first object, based on failing to obtain the symbol information using the symbol scanner, the issue classification for the first object corresponding to a second routing path for the first object within the transport system,

10. The system of claim 9, wherein the one or more computing devices are further configured to override the issue classification to control the routing of the first object within the transport system optionally

11. The system of claim 10, further comprising a redirection device that is positioned downstream of the symbol scanner within the transport system, the redirection device being configured to move the objects from a first routing path to a second routing path,
wherein the one or more computing devices are configured to control the routing of the first object by preventing the redirection device from moving the first object to the second routing path, thereby allowing the first object to continue traveling along the first routing path within the transport system past the redirection device, based on the overriding of the issue classification.

12-20. (canceled)

21. The system of claim 2, wherein the one or more computing devices are further configured to determine that the first object is the first type of object based on at least one of the total number or the frequency exceeding a threshold value.

22. The system of claim 6, wherein the first dimension is at least one of a height, a length, a width, or a volume.

23. The system of claim 9, wherein the issue classification is a no-read issue classification.

24. The system of claim 10, wherein overriding the issue classification includes at least one of:
associating the first symbol information with the first object to control routing of the first object;
removing the issue classification for the first object;
preventing recirculation of the first object through the transport system; or
ignoring the issue classification for the first object relative to travel of the first object through the transport system.
